(19) United States
(12) Patent Application Publication
(10) Pub. No.: US 2026/0305621 A1
(43) Pub. Date: Oct. 8, 2026

(54) A METHOD OF OPERATING A BAKING OVEN AND BAKING OVEN

(71) Applicant: E.G.O. Elektro-Gerätebau GmbH, Oberderdingen (DE)

(72) Inventors: Marcus Frank, Sulzfeld (DE); Elisabeth Stötzner, Bretten (DE); Marius Lehner, Mühlacker (DE); Christian Seidler, Bretten (DE); Magdalena Bauer, Zaberfeld (DE); Carmelo Zarcone, Oberderdingen (DE); Hector Farreres, Llicà de Vall (ES); Mario Funk, Karlsdorf-Neuthard (DE)

(21) Appl. No.: 19/482,274

(22) PCT Filed: May 6, 2025
(86) PCT No.: PCT/EP2024/062410

§ 371 Date: Nov. 7, 2025

(30) Foreign Application Priority Data
May 16, 2023 (EP) 23382455.6

(51) Int. Cl. A21B 1/22; A21B 1/40; A21B 2/00; A23L 5/10; F24C 15/32; H05B 3/42

(52) U.S. Cl. CPC A21B 1/22; A21B 1/40; A21B 2/00; A23L 5/15; H05B 3/42; F24C 15/322; H05B 2203/005

(57) ABSTRACT

In a method for operating a baking oven with at least one radiation heating device in a muffle, a food support for placing food for heat treatment in the muffle, a temperature sensor in the muffle and a baking oven control unit, the baking oven control unit determines the energy generated by the heating device, and determines the temperature detected by the temperature sensor and the temperature of the heating device. The baking oven control unit will then determine the influence of a radiation heat flow emanating directly from the heating device on the food on the basis of stored values, and determines the influence of the convection heat flow based on the temperature measured by the temperature sensor. The baking oven control unit also determines the temperature of the upper side of the food, and will then regulate the power of the heating device on the basis of a comparison between the preset temperature and the determined temperature at the food to be cooked in order to bring the determined temperature at the food to the preset temperature.

### FIELD OF APPLICATION AND PRIOR ART

The invention is directed to a method for operating a baking oven as well as to a baking oven which is designed to operate according to this method.

It is known for example from DE 10 2009 048 495 A1 or from EP 22383198.3 with a filing date of Dec. 9, 2022, to operate a baking oven with a heating element being arranged at an upper sealing wall of a muffle of the baking oven in a grill mode. The heating element is a so-called tubular heating element. This serves for example to grill toast, vegetables or the like. This can be done for a completely covered baking tray.

### Problem and Solution

It is an object of the invention at hand to provide a method for operating a baking oven as well as such a baking oven to overcome problems in the art and, in particular, to provide a method which is specifically and in detail adapted to have more control over the baking or grilling process.

This object is solved by a method for operating a baking oven having the features of claim 1 as well as by such a baking oven having the features of claim 14. Advantageous and preferred configurations of the invention are the subject of the further claims and are explained in more detail below. Some of the features may be described only with regard to the method or only with regard to the baking oven. However, regardless of this, they are intended to be able to apply by themselves for the method for operating a baking oven and for the baking oven independently of one another. The wording of the claims is made to the content of the description by means of express references.

The baking oven of the invention comprises an oven muffle having walls, an access opening to the muffle and a door for closing this access opening. The baking oven also comprises at least one heating device in the muffle, which heating device is adapted to generate radiation energy or radiation heat, respectively, at a temperature greater than 650° C. This temperature may be up to 800° C., such that a major and preferably the largest part of the energy with which the heating device is provided is transformed into radiation energy. The heating device is disposed or mounted on an upper sealing wall of the muffle, preferably at the underside of this upper sealing wall. In preferred manner, the heating device may be a so-called tubular heating element, which for example is known from DE 102009048495 A1 mentioned above. It will be described hereinafter in greater detail.

The baking oven also comprises a power supply for the heating device, preferably for all heating devices of the baking oven. It also comprises a food support in the muffle, which in particular can be an oven rack or a baking tray. The food support serves for placing food for heat treatment in the muffle, for example a steak to be grilled. Also a temperature sensor is provided in the muffle, preferably as is known in the art. The temperature sensor may stand freely in the muffle or may protrude from a wall of the muffle. The temperature sensor can either be adapted for evaluation by an electronic control or by a thermo-mechanical device which transforms a temperature change into a movement. Also this is known in the art. The baking oven also has a baking oven control unit which is connected to the power supply for the control of this power supply or of the heating device, respectively. Also the temperature sensor is connected to the baking oven control unit for its evaluation or temperature measurement, respectively.

According to the invention, the method has several steps which can follow each other, in particular directly or with intermediate steps, which are described later in detail. In a preceding step, the baking oven control unit determines or detects the energy generated or emitted by the heating device, wherein this determination or detection takes place at the power supply for the heating device. As the power supply is connected to the baking oven control unit anyway, this is particularly easy. In this way, also the temperature can be detected by the temperature sensor and also by the baking oven control unit. It is possible that a user has already entered a target temperature for the food. Alternatively, a respective cooking program for specific food may have been chosen by the user at the baking oven control unit, preferably at a user interface of it.

In a next step, the baking oven control unit determines the temperature of the heating device. This may be done in various ways, one is a measurement and the other is a calculation based on the operating time of the heating device and the electrical heating parameters. The temperature of the heating device may preferably be determined or measured continuously during its operation, so not only at one point in time.

In a next step, the baking oven control unit determines, on the basis of the determined temperature of the heating device, the influence that a radiation heat flow has on the food to be cooked, which radiation heat flow emanates directly from the heating device. Furthermore, this is made based on stored values in the baking oven control unit, for example by taking into account the temperature of the heating device. The stored values concern mainly parameters of the baking oven that indicate what radiation heat flow emanates from the heating device depending on its temperature. This may mainly be according to the Stefan-Boltzmann-Law.

In a next step, the baking oven control unit determines the influence that the convection heat flow has on the food, which determination is made based on the temperature measured by the temperature sensor. This temperature sensor thus measures the air temperature in the muffle. In consequence, the temperature of the heating device, which determines the radiation heat flow, and the temperature of the air in the muffle, which determines the convection heat flow, are both taken into account for treating the food.

In a further step, the baking oven control unit determines, based on the values stored therein and based on the temperature detected by the temperature sensor, the temperature of the upper side of the food, which upper side faces the heating device and is also heated by the hot air in the muffle. The radiation heat flow and the convection heat flow that both come from the heating device are taken into account for determining the temperature of the food or its upper side, respectively.

Furthermore, a preset temperature for the food may have been preset in the baking oven control unit. This preset temperature may either come from a cooking program that a user has started as explained above. Alternatively, it may have directly been entered by a user. Both alternatives can be realized in the baking oven control unit. Then the baking oven control unit changes or regulates the power of the heating device, in particular via the power supply, on the basis of a comparison between the preset temperature and the determined temperature at the food or its upper side, respectively. This serves to bring the determined temperature at the food to match with the preset temperature allowing for a temperature controlled food preparation method, in particular in a grilling process for food such as meat.

The invention thus allows for a method and for a baking oven to bring a temperature of food, either at its upper side or in its core, to match with a preset temperature without having to directly implement a temperature measurement directly at or in the food to be prepared.

In an embodiment of the invention, the food support may be arranged with a vertical distance between the uppermost region of the food thereon and the heating device before the start of operation of the baking oven of at most 15 cm, in particular at most 12 cm, in some cases only 2 cm to 5 cm. This vertical distance preferably is at least 1 cm. At such short distance, the grilling effect, mainly based on radiation heat flow, is at a maximum or very high at least.

In a further embodiment of the invention, the temperature T(t) of the heating device can be determined with the following formula for T(t):

$$T ( t ) = T ( t - \breve{1 s} ) + DF ( P ) \breve{*} [ {T}_{steady} ( P \breve{P ) -} T ( t - 1 s ) ]$$

So this temperature determination is based on a continuous monitoring of the temperature. T_{steady} is the temperature of the heating device that may be reached after a long time of operation with continuous power, for example after 5 to 8 minutes. The higher the continuous power P is, the higher the temperature T_{steady} of the heating device will be. So the temperature T_{steady} is a function of P. DF(P) is a delay factor that is also dependent on the power supplied to the heating element. It becomes higher with rising continuous power, in a way similar to the temperature T_{steady}. In the formula shown above, the temperature of the heating device is determined every second.

In a further embodiment of the invention, the temperature T_{food} at the upper side of the food is determined with the following formula for T_{food}(t):

$${T}_{food} ( t ) = a * ( {T}_{THE}^{4} - {T}_{food}^{4} ( t - 1 s ) ) + {T}_{a i r}$$

T_{THE} is the temperature of the heating element, and Tₐᵢᵣ is temperature of the air in the muffle which was detected by the temperature sensor. The temperature sensor may be located close to the heating device or to the upper ceiling wall of the muffle to measure the temperature of the air close to the heating device and, above all, close to the food. Depending on the position of the sensor, Tₐᵢᵣ might be the sensor temperature plus or minus a temperature offset, which takes into account the temperature difference between the temperature at the location of the food and the temperature at the location of the sensor. This is known in the art. Also in this formula, the temperature T_{food} of the food is determined every second based on its temperature 1 second before. “a” is an empirically determined factor based on test results with such a baking oven, wherein “a” can be stored in the baking oven control unit. This factor can also be dependent on the power P of the heating device and/or the air temperature Tₐᵢᵣ in the muffle.

Preferably, the power P as a setting for the heating device can be determined as:

$$P = Kp * ( T\_desired - {T}_{f o o d} )$$

Kp is a proportional gain, which can also be empirically determined and be stored in the baking oven control unit. T_desired is the preset temperature as explained before. T_{food} is the temperature of the food calculated as described above. Of course any other kind of closed loop controller might be used which is known from the prior art, like PID or others.

In another embodiment of the invention, the heating device may be operated in a clocked manner. This can in particular be with an actual or a momentary power P, which is either zero or is a permanent maximum power. This permanent maximum power can also be seen as a nominal power. The invention may provide pulse-width-modulation for the most cost-effective way of realizing the power setting. By making that choice Flicker requirements of DIN EN 61000 have to be taken into consideration, limiting the count of switching and the load switched simultaneously. It is also favourable to reduce the amount of switching cycles in order to reduce the stress for the switching relays during the whole lifetime. Additionally, it may be considered to keep the current drawn simultaneously from the grid by the baking oven as low as possible. This means that other heating elements of the baking oven, such as e.g. bottom heat, ring heaters, steamer, microwave, inside the oven might be able to be operated in parallel, still complying with 16A nominal current for the appliance.

For the power setting the following process may be applied: Depending on the equipment of the oven with 1 or 2 circuit tubular heating elements, or maybe even more circuits, different cycle times for the pulse-width-modulation may be necessary. In case 2 tubular heating elements with each 1.500 W are used, e. g. the switching time of 15 sec can be used to comply with Flicker. By having for example one tubular heating element with 1.000 W and one tubular heating element with 2.000 W nominal power this would result in cycle times for the pulse-width-modulation of 20 sec. This is way more advantageous than using just one heating element with 3.000 W which would need a switching time of about 60 sec for complying with Flicker. On the other hand long cycle times are resulting in large or major temperature oscillation of the temperature of the tubular heating element and further resulting in charred food due to the temperature being too high. In case 2 tubular heating elements are provided they are operated sequentially to each other in order to draw less current from the grid in parallel. The switching times of the tubular heating elements are arranged in a way that the off-time of the first upper tubular heating element is slightly before the on-time of the second lower tubular heating element:

| | | | | | |
|---|---|---|---|---|---|
| On | On | On | | | |
| | | | On | On | On |

In a further embodiment of the invention, the temperature sensor can be arranged in the upper region of the muffle, in particular above the height of the food support mentioned before. The temperature sensor can be arranged at most 2 cm to 5 cm below an upper ceiling wall or on the upper ceiling wall of the muffle. This may guarantee for the temperature sensor to always be located above the food or the food support, respectively, which allows for precise temperature measurement of the air in the region around the food.

In a preferred embodiment of the invention, the heating device has a plurality of separate heating elements, which can be operated separately from one another. The individual heating elements can be operated or switched on not simultaneously but alternately or successively as described above. This may in particular be in such a way that, at least during a transition of operation, one heating element is switched off and the other heating element is switched on directly at the same moment.

The heating device may have or comprise at least one tubular heating element as heating element, preferably a permanent maximum power being between 1.000 W and 2.000 W, in some cases even higher. Preferably, as explained before, two tubular heating elements are provided. They can be as a single circuit or a double circuit as grill plus so-called upper heat. The control algorithm of the baking oven control unit is preferably applicable to both configurations.

A temperature of the heating device can be at least 500° C. for good grilling results, preferably at least 700° C. In particular the temperature may even be above 800° C., for example up to 900° C. This is possible with the tubular heating elements described above.

In preferred manner, a power density of the heating device or of the tubular heating elements, respectively, may be at least 5 W/cm², preferably at least 6.5 W/cm². It may at most be up to 7 W/cm², which is a rather high power density and sufficient for good grilling results.

Due to the close proximity of the food support to the heating device, and the high temperature of the heating device, there is a large heat transfer by radiation heat flow, which is preferred for intense grilling or searing. The heat transfer is not only by radiation heat flow but also by convection over the air inside the muffle. The task of the invention is to create a control algorithm which is taking into account both heat transfer mechanisms, which is radiation heat flow and convection heat flow. This but still gives the user the possibility to make the intensity adjustments by setting a temperature for the food.

In a preferred embodiment of the invention, the baking oven control unit may determine the temperature of the heating device either on the basis of the energy generated or emitted by the heating device, or on the basis of a temperature measurement by means of a temperature sensor arranged on the heating device or by means of a temperature sensor integrated in the heating device. The first option has the advantage of a smaller number of components needed, while the second option may result in a more accurate temperature determination.

These and further features are evident not only from the claims but also from the description and the drawings, the individual features each being implemented by themselves or in multiples in the form of subcombinations for an embodiment of the invention and in different fields and being able to be advantageous and independent protectable embodiments for which protection is claimed here. The division of the application into individual sections and subheadings does not limit the general validity of the statements made thereunder.

### BRIEF DESCRIPTION OF THE DRAWINGS

FIG. 1 an oblique view from the front onto a baking oven according to the invention with an open door for the muffle,

FIG. 2 a front view into the open muffle where a heating device with three fingers is arranged at an upper ceiling of the muffle,

FIG. 3 a schematic view into the baking oven according to FIG. 2 with a food support and some steaks on it as food to be grilled,

FIG. 4 a view from below onto the ceiling of the muffle with the three fingers of the heating device made up of a tubular heating element,

FIG. 5 a view similar to that of FIG. 2 into an alternative baking oven with an additional second tubular heating element as further heating device,

FIG. 6 several curves for a temperature above time depending on the power density at the surface of a tubular heating element,

FIG. 7 two curves for the course of a steady state temperature above continuous power P of a tubular heating element, also showing the dependency of a delay factor DF (P) in two alternatives, and

FIG. 8 a diagram showing the distribution over time of a temperature T, which is a combination of convection heat flow and radiation heat flow, also shown in dependency of a target temperature which is rather high in the beginning and then is set to be somewhat lower.

### DETAILED DESCRIPTION OF THE EMBODIMENTS

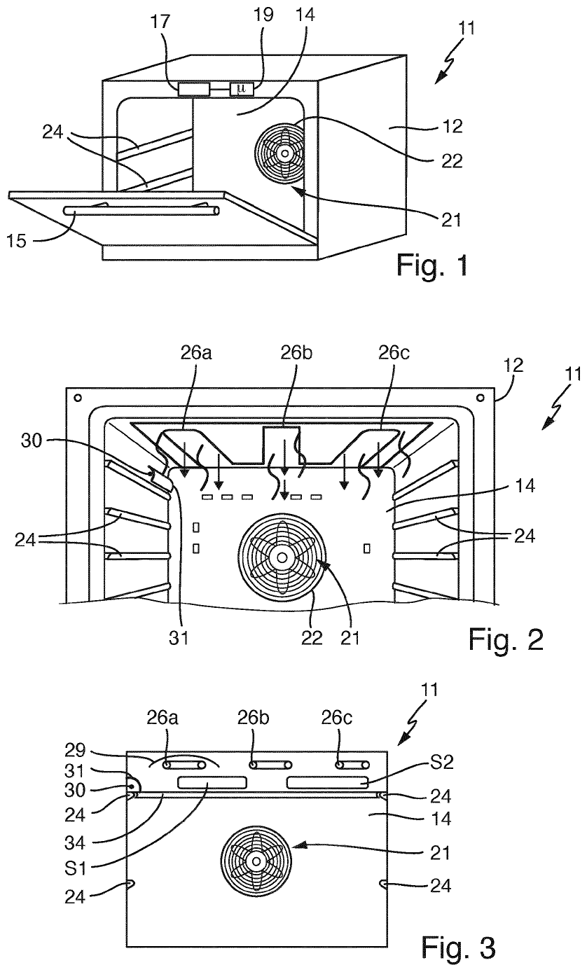

In FIG. 1 a baking oven 11 is shown with a housing 12 and a cavity or muffle 14 therein. The muffle 14 can be closed in conventional manner with a muffle door 15. Above the muffle door 15 a user interface 17 is provided, preferably having control elements on it as is known in the art, advantageously also a display. The user interface 17 is connected to a baking oven control unit 19, which preferably has a microcontroller and a storage unit. In the storage unit of the baking oven control unit 19, various cooking or grilling programs as well as various parameters are stored.

At a backside of the muffle 14 a fan 21 is provided, which may be adapted to operate for a circulating mode as well as for a convection oven as is known in the art. It may be provided with an additional heater which is not shown here for blowing hot air into the baking oven 11. A conventional fan grill 22 is shown.

At the side walls of the muffle 14 various rails 24 are provided. They can be constructed as is conventional in the art and may be fabricated either by stamping a metal wall of the muffle 14 or by fixing, preferably with screws, respective rails to the wall. These rails 24 are horizontal and parallel to each other on the left side wall and on the right side wall of the muffle 14.

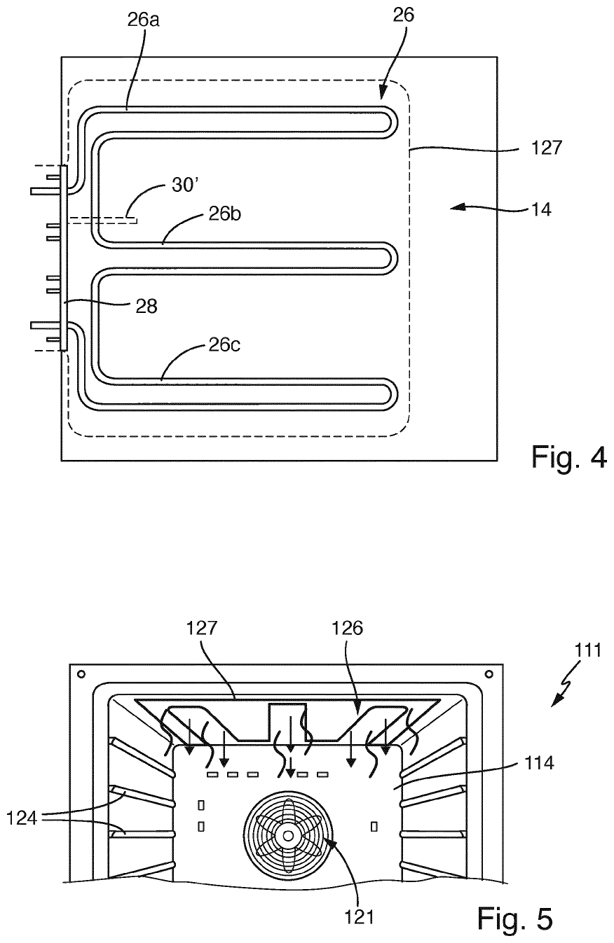

In basically known manner the heating device 26 with three fingers 26a, 26b and 26c is arranged at the ceiling wall of the muffle 14. As can be taken in detail from FIG. 4, the heating device 26 is made of one continuous tubular heating element formed into the three fingers 26a to 26c. This heating device 26 could also be divided into two or even three separate heating devices, such that its operation can be better adapted to a power need in the muffle 14 as well as according to a demand for a heat distribution. It might also be provided that one single or each one of the fingers 26a to 26c is made up of a separate and independent tubular heating element. Another alternative is shown in FIG. 5 as a second, frame-like tubular heating element 27, which is shown in a dashed line in FIG. 4. These separate and independent tubular heating elements can be operated as described above, preferably in a sequential operating mode.

The heating device 26 may be affixed to the rear muffle wall with a metal carrier 28. This is also known in the art.

A food support in the form of an oven rack 34 is provided in the muffle 14, which is held in the uppermost rail 24 with a distance of 10 cm underneath the heating device 26. It should be provided as a closed rack. Two steaks S1 and S2 are provided on it, but there could also be more steaks. They are to be grilled in the muffle 14, for which reason a user has chosen a specific grill cooking program at the user interface 17 and on the baking oven control unit 19. It can be taken from FIG. 3 that the steaks S1 and S2 are placed with only a minimum distance of a few centimeters, for example 4 cm or 5 cm, underneath the loops 26a to 26c of the heating device. This serves for the major amount of radiation heat flow to be onto the steaks, which obviously is good and very efficient for the grilling process.

Furthermore, a temperature sensor 30 is located at the left side wall of the muffle 14, which can also be taken from FIG. 2. This temperature sensor 30 is protected against direct heat or radiation heat from the heating device 26 by a shield 31, which may preferably be a metal sheet with good reflecting properties. In this way, the temperature of the air in the region of the steaks S1 and S2 can be measured exactly.

It is also shown for the left finger 26a of the tubular heating element to be provided with a reflector 29 above it. Such an exemplary reflector is also known in the art and may serve for concentrating a radiation heat flow downwards onto the steaks S1 and S2, in particular onto the left steak S1.

The temperature sensor 30 might be an electrical temperature dependent resistor, for example an NTC, a PT100 or a PT1000. An alternative temperature sensor 30′ is shown in FIG. 4, which is an elongate temperature sensor with thermomechanical construction.

From the alternative baking oven 126 of FIG. 5 it can be taken that the additional heating device 127 allows for not only a higher overall heating power, but also for an alternative grilling as described initially. Both heating devices 126 and 127 can be operated alternatively, preferably one exactly after the other as is described above with the table of exemplary on-times, but never at the same time simultaneously.

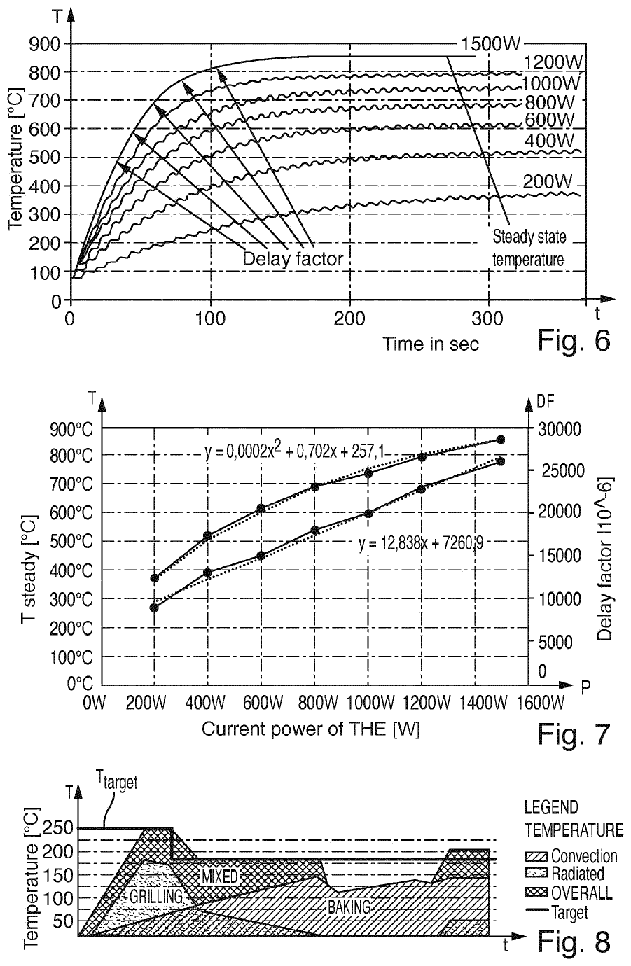

FIG. 6 shows several curves of the temperature of a tubular heating element 26 over the time t, which is dependent on the medium or constant power P, with which the tubular heating element 26 is operated. If, for example, it is operated according to the table described above with three times out of ten in an on-mode, and seven out of ten times in an off-mode, which corresponds to a PWM factor of 0.3, and the nominal power of the tubular heating element is 1.500 W, this corresponds to 450 W. So the various powers 200 W, 400 W, 600 W, 800 W, 1.000 W and 1.200 W of FIG. 6 can be achieved by varying this PWM factor. The power of 1.500 W would then be given when the tubular heating element 26 is permanently in the on-mode.

A maximum temperature with this nominal power of 1.500 W of about 850° C. is reached after about 180 seconds, and then will be constant. The maximum temperature of course is reduced with less medium power, and of course it also takes more time to reach this maximum temperature. With the lowest medium power of 200 W, this may take up to seven or eight minutes.

The arrows in the region between 30 seconds and 100 seconds show how the delay factor DF can be determined for a specific medium power, which is also shown in FIG. 7. This delay factor DF (P) is a scalar value without any unit.

The diagram of FIG. 7 shows the steady temperature T_steady that can be achieved with various medium powers according to FIG. 6. These medium powers are along the x-axis. Along the right vertical axis, this delay factor DF (P) is shown. An example for one tubular heating element 26 is shown. The upper darker line is showing the temperature T_steady, and the lower lighter line is showing the delay factor DF. They could also be viewed or approximated as straight lines or graphs according to the lower straight line. Either a plurality of values could be stored in a storage of the baking oven control unit 19, alternatively those lines or graphs, respectively, could be stored.

FIG. 8 shows the course of temperature T over time t, which is according to the continuous straight line the target temperature T_{target} of the steaks S1 and S2 of FIG. 3. This target temperature is preset in this way, meaning that the target temperature should be high, for example 250° C., for the first 100 seconds. Then a first grilling or searing of the steaks has been achieved, such that either the process can be stopped or, as shown in FIG. 8, it can continue, whereas for the continuation the target temperature is lowered somewhat to 175° C. This temperature is achieved partly from radiation heat flow as “grilling”, and partly, although somewhat slower, from convection heat flow according to “baking”. Together they make a mixed or overall heat flow into the food to be cooked, which is according to FIG. 3 the steaks S1 and S2.

1-16. (canceled)

17. A method for operating a baking oven, said baking oven comprising:
a muffle having walls, an access opening to said muffle, and a door for closing said access opening,
at least one heating device in said muffle, said heating device being adapted to generate radiation heat at a temperature greater than 650° C. and said heating device being disposed on an upper ceiling wall of said muffle,
a power supply for said heating device,
a food support for placing food for heat treatment in said muffle,
a temperature sensor in said muffle,
a baking oven control unit being connected to said power supply for its control, and being connected to said temperature sensor for its evaluation,
wherein
said baking oven control unit determines, at said power supply for said heating device, said energy generated by said heating device, and determines said temperature detected by said temperature sensor by means of being connected to said temperature sensor,
said baking oven control unit determines a temperature of said heating device
either on a basis of said energy generated or emitted by said heating device,
or on a basis of a temperature measurement by means of a temperature sensor arranged on said heating device or by means of a temperature sensor integrated in said heating device,
said baking oven control unit determines, on a basis of said determined temperature of said heating device, an influence of a radiation heat flow emanating directly from said heating device onto said food to be cooked on a basis of stored values, wherein said stored values concern parameters of said baking oven indicating what radiation heat flow emanates from said heating device depending on its temperature,
said baking oven control unit determines an influence of a convection heat flow in said muffle based on said temperature measured by said temperature sensor,
said baking oven control unit determines, on a basis of values stored therein and on a basis of said temperature detected by said temperature sensor, a temperature of an upper side of said food facing said heating device, on a basis of said radiation heat flow and on a basis of a convection heat flow emanating from said heating device via the air,
a preset target temperature for said food is preset in said baking oven control unit,
said baking oven control unit changes or regulates a power of said heating device on a basis of a comparison between a preset target temperature and said determined temperature at said upper side of said food to be cooked in order to bring said determined temperature at said upper side of said food to said preset target temperature.

18. Method according to claim 1, wherein said food support is arranged with a vertical distance between an uppermost region of said food thereon and said heating device of at least 1 cm and at most 15 cm before a start of operation of said baking oven.

19. Method according to claim 1, wherein said temperature of said heating device is determined with a formula for T(t):
$$T ( t ) = T ( t - \breve{1 s} ) + DF ( P ) \breve{*} [ {T}_{steady} ( P \breve{P ) -} T ( t - 1 s ) ]$$

20. Method according to claim 1, wherein said temperature at said upper side of said food is determined with a formula T_{food}(t):
$${T}_{food} ( t ) = a * ( {T}_{THE}^{4} - {T}_{food}^{4} ( t - 1 s ) ) + {T}_{a i r}$$

21. Method according to claim 1, wherein said heating device is operated in a clocked manner.

22. Method according to claim 5, wherein said heating device is operated in a clocked manner with a momentary power being either zero or being a permanent maximum power.

23. Method according to claim 2, wherein said temperature sensor is arranged in said upper region of said muffle and above a height of said food support.

24. Method according to claim 7, wherein said temperature sensor is arranged at most 5 cm below an upper ceiling wall or on said upper ceiling wall.

25. Method according to claim 1, wherein said heating device has a plurality of separate heating elements which can be operated separately from one another, said individual heating elements being operated or switched on not simultaneously but alternately or successively.

26. Method according to claim 9, wherein said individual heating elements are operated or switched on alternately or successively in such a way that, at least during a transition of operation, one said heating element is switched off and a different one of said heating elements is switched on directly at the same time.

27. Method according to claim 1, wherein said heating device has at least one tubular heating element as heating element.

28. Method according to claim 11, wherein said at least one tubular heating element has a permanent maximum power being between 1.000 W and 2.000 W.

29. Method according to claim 1, wherein a temperature of said heating device is at least 700° C.

30. Method according to claim 1, wherein a power density of said heating device is at least 6.5 W/cm².

31. Baking oven, wherein said baking oven comprises:
a muffle having walls, an access opening to said muffle, and a door for closing said access opening,
at least one heating device in said muffle, said heating device being adapted to generate radiant heat at a temperature greater than 650° C., and said heating device being disposed on an upper ceiling wall of said muffle,
a power supply for said heating device,
a food support for placing food for treatment in said muffle,
a temperature sensor in said muffle,
a baking oven control unit which is connected to said power supply for control and is connected to said temperature sensor for its evaluation,
wherein said baking oven control unit is designed to carry out said method according to claim 1.

32. Baking oven to claim 1, wherein said temperature sensor in said muffle stands freely in said muffle or protrudes from a wall of said muffle.
